(19) United States
(12) Patent Application Publication
(10) Pub. No.: US 2025/0328395 A1
(43) Pub. Date: Oct. 23, 2025

(54) EDGE COMPUTING NODE SYSTEM AND METHOD OF OFFLOADING TASK BETWEEN NODES

(71) Applicant: LUXSHARE PRECISION INDUSTRY COMPANY LIMITED, Shenzhen (CN)

(72) Inventors: Guan Hsiung WANG, Shenzhen (CN); Wei Hsin CHEN, Shenzhen (CN)

(21) Appl. No.: 18/886,284

(22) Filed: Sep. 16, 2024

(30) Foreign Application Priority Data
Apr. 19, 2024 (CN) 2024104744137

(51) Int. Cl. G06F 9/50; G06F 9/54

(52) U.S. Cl. CPC G06F 9/5088; G06F 9/54; G06F 2209/509; G06F 2209/541

(57) ABSTRACT

An edge computing node system and a method of offloading task between nodes used in an edge computing network with an edge side and a client side are provided. In the edge computing node system, when being unable to process the offload request of a client device, a local server selects one of a plurality of node servers which is suited to process the offload request as a target server by a classifying procedure and evaluation of response signals, and the target server obtains and processes the offload request from the local server so that the offload request is immediately processed without suspending.

### CROSS-REFERENCE TO RELATED APPLICATIONS

This application claims the priority benefit of Chinese Patent Application Serial Number 2024104744137, filed on Apr. 19, 2024, the full disclosure of which is incorporated herein by reference.

### TECHNICAL FIELD OF THE INVENTION

The present disclosure is related to a technical field of edge computing and is particularly related to an edge computing node system and a method of offloading task between nodes.

### DESCRIPTION OF THE PRIOR ART

Due to the technical development of IoT (Internet of Things), a 5G heterogeneous network, edge computing and cloud computing, the data operation and the data storage of some local client devices would be implemented by a cloud server. However, the data propagation delay of the local client device may be caused because the cloud server is far away from the local client device on network layers or actual geographic positions. As the number of the local client devices daily increases, the amount of transmitted data between the local client devices and the cloud server daily increases, and the bandwidth of the current cloud server may have difficulty in undergoing the extremely large amount of data. In addition, there are risks on data safety because the distance between the cloud server and the local client device on the network layers is large.

In light of the greater distance between the local client device and the cloud server, an edge computing network is accordingly generated and includes a plurality of edge devices, and one edge device may correspond to at least one local client device. Each of the plurality of edge devices assists in the data processing and the data storage of the corresponding local client device, thereby improving the reliability and the safety of the data and reducing the propagation delay of the data. However, the capability of each of the plurality of edge devices is limited and cannot immediately assist the data processing and the data storage of the corresponding local client device every time.

### SUMMARY

In light of the aforementioned descriptions, the present disclosure provides an edge computing node system and a method of offloading task between nodes to solve the problem that the edge device cannot assist the data processing and the data storage of the local client device due to limited capability thereof.

Based on the aforementioned considerations, the present disclosure is to provide an edge computing node system for an edge computing network with a client side and an edge side. The edge computing node system includes a client device, a local server, and a plurality of node servers. The client device is disposed on the client side and transmits an offload request. The local server is disposed on the edge side and is connected to the client device. The local server ensures a first assistance calculation capability, a first assistance capacity and a first thread, calculates first delay time according to the first assistance calculation capability and the offload request, and transmits an ensuring request. The plurality of node servers are disposed on the edge side and is wirelessly connected to the local server and the client device respectively, wherein each of the plurality of node servers ensures and transmits a second assistance calculation capability and the ensuring result about a second assistance capacity and a second thread to the local server according to the ensuring request. When the first assistance capacity is not greater than a preset capacity, the local server does not have the first thread or the first delay time does not lie within a preset time range, and the local server obtains the plurality of response signals from the plurality of node servers, the local server performs a classification procedure on each of the plurality of node servers. The classification procedure includes: calculating second delay time according to the second assistance calculation capability and the offload request; when determining that the node server has the second thread, the second assistance capacity is greater than the preset capacity and the second delay time lies within the preset time range, classifying the node server as a target type node server. When the number of the target type node server is at least one, the local server selects a target server from the at least one target type node server according to the response signal corresponding to the at least one target type node server, and the target server obtains the offloading message about the offload request from the local server and performs the offload request on the second thread.

In some embodiments of the present disclosure, the local server is a local MEC server, and the plurality of node servers are MEC servers.

In some embodiments of the present disclosure, when the number of the target type node servers are multiple, selecting the target server from the target type node servers according to the response signals corresponding to the target type node servers performed by the local server includes: generating the distance between each of the target type node servers and the local server and the channel timing delay and the channel quality of each of the target type node servers according to the response signals corresponding to the target type node servers; selecting the target server from the target type node servers according to the channel timing delays, the channel quality and the distances of the target type node servers.

In some embodiments of the present disclosure, when the first assistance capacity is greater than the preset capacity, the local server has the first thread, and the first delay time lies within the preset time range, the local server determines whether to retain the first assistance calculation capability. When determining to retain the first assistance calculation capability and obtaining the response signal from at least one of the plurality of node servers, the local server performs the classification procedure on the node server corresponding to the response signal. When determining not to retain the first assistance calculation capability, the local server performs the offload request on the first thread.

In some embodiments of the present disclosure, when determining to retain the first assistance calculation capability and not obtaining the response signals from the plurality of node servers after preset wait time, the local server performs the offload request.

In some embodiments of the present disclosure, when the first assistance capacity is not greater than the preset capacity, the local server does not have the first thread, the first delay time does not lie within the preset time range, and not obtaining the plurality of response signals from the plurality of node servers after the preset wait time, the local server performs the offload request.

In some embodiments of the present disclosure, the classification procedure further includes: when determining that the node server does not have the second thread, the second assistance capacity is not greater than the preset capacity or the second delay time does not lie within the preset time range, classifying the node server as a non-target type node server.

In some embodiments of the present disclosure, when the plurality of node servers belong to the non-target type node server, the local server determines whether the offload request is a real-time calculation request.

In some embodiments of the present disclosure, the edge computing network further includes a cloud side, and the edge computing node system further includes a cloud server. The cloud server is disposed on the cloud side and is connected to the local server. When determining that offload request is the real-time calculation request, the local server refuses the offload request and transmits an assistance message to the cloud server, and the cloud server examines the operation situations of the local server and the plurality of node servers. When determining that offload request is not the real-time calculation request, the local server transmits the offload request and the assistance message to the cloud server, and the cloud server processes the offload request.

In some embodiments of the present disclosure, the local server performs an identification procedure on the client device to generate an identification result when receiving the offload request. When the identification result is a legal client, the local server ensures the first assistance calculation capability, the first assistance capacity and the first thread, and calculates the first delay time according to the first assistance calculation capability and the offload request and transmits the ensuring request to the plurality of node servers. When the identification result is an illegal client, the local server refuses the offload request.

In some embodiments of the present disclosure, the local server includes a first radio frequency transceiver, a first processor, a second radio frequency transceiver, and a second processor. The first radio frequency transceiver receives the offload request. The first processor is connected to the first radio frequency transceiver and performs the identification procedure on the client device. The second radio frequency transceiver transmits a communication message or a handshake message to the plurality of node servers, and the plurality of node servers transmit the plurality of response signals to the second radio frequency transceiver according to the communication message or the handshake message. The second processor is connected to the second radio frequency transceiver and performs the identification procedure on each of the plurality of node servers.

In some embodiments of the present disclosure, the plurality of node servers are connected with each other by LoRa networks. The second radio frequency transceiver transmits the communication message or the handshake message to the plurality of node servers by the LoRa networks, and the plurality of node servers transmits the plurality of response signals to the second radio frequency transceiver by the LoRa networks according to the communication message or the handshake message.

Based on the aforementioned considerations, the present disclosure is to provide a method of offloading task between nodes for an edge computing network with a client side and an edge side. The method of offloading task between nodes performed by the local server disposed on the edge side includes: receiving the offload request from the client device disposed on the client side; ensuring a first assistance calculation capability, a first assistance capacity and a first thread, and calculating first delay time according to the first assistance calculation capability and the offload request; transmitting an ensuring request to a plurality of node servers disposed on the edge side; receiving a corresponding second assistance calculation capability and the ensuring result about a second assistance capacity and a second thread from each of the plurality of node servers; when the first assistance capacity is not greater than a preset capacity, there is not the first thread in the local server or the first delay time does not lie within a preset time range, and obtaining the plurality of response signals from the plurality of node servers, performing a classification procedure on each of the plurality of node servers, and the classification procedure includes: calculating second delay time according to the second assistance calculation capability and the offload request; when determining that the node server has the second thread, the second assistance capacity is greater than the preset capacity and the second delay time lies within the preset time range, classifying the node server as a target type node server; when the number of the target type node server is at least one, selecting a target server from the at least one target type node server according to the response signal corresponding to the at least one target type node server, and obtaining the offloading message about the offload request from the local server and performing the offload request on the second thread by the target server.

In some embodiments of the present disclosure, when the number of the target type node servers are multiple, selecting the target server from the target type node servers according to the response signals corresponding to the target type node servers includes: generating the distance between each of the target type node servers and the local server and the channel timing delay and the channel quality of each of the target type node servers according to the response signals corresponding to the target type node servers; selecting the target server from the target type node servers according to the channel timing delays, the channel quality and the distances of the target type node servers.

In some embodiments of the present disclosure, the method of offloading task between nodes further includes: when the first assistance capacity is greater than the preset capacity, there is the first thread in the local server, and the first delay time lies within the preset time range, determining whether to retain the first assistance calculation capability; when determining to retain the first assistance calculation capability and obtaining the response signal from at least one of the plurality of node servers, performing the classification procedure on the node server corresponding to the response signal; when determining not to retain the first assistance calculation capability, performing the offload request on the first thread.

In some embodiments of the present disclosure, the method of offloading task between nodes further includes: when determining to retain the first assistance calculation capability and not obtaining the response signals from the plurality of node servers after the preset wait time, performing the offload request.

In some embodiments of the present disclosure, the method of offloading task between nodes further includes: when the first assistance capacity is not greater than the preset capacity, there is not the first thread in the local server, the first delay time does not lie within the preset time range, and not obtaining the plurality of response signals from the plurality of node servers after the preset wait time, performing the offload request.

In some embodiments of the present disclosure, the classification procedure further includes: when determining that the node server does not have the second thread, the second assistance capacity is not greater than the preset capacity or the second delay time does not lie within the preset time range, classifying the node server as a non-target type node server.

In some embodiments of the present disclosure, the method of offloading task between nodes further includes: when the plurality of node servers belong to the non-target type node server, determining whether the offload request is a real-time calculation request.

In some embodiments of the present disclosure, the edge computing network further includes a cloud side. The method of offloading task between nodes further includes: when determining that offload request is the real-time calculation request, refusing the offload request and transmitting an assistance message to the cloud server belonging to the cloud side, and examining the operation situations of the local server and the plurality of node servers by the cloud server; when determining that offload request is not the real-time calculation request, transmitting the offload request and the assistance message to the cloud server, and processing the offload request by the cloud server.

In some embodiments of the present disclosure, the method of offloading task between nodes further includes: when receiving the offload request, performing an identification procedure on the client device to generate an identification result; when the identification result is a legal client, ensuring the first assistance calculation capability, the first assistance capacity and the first thread, and calculating the first delay time according to the first assistance calculation capability and the offload request; transmitting the ensuring request to the plurality of node servers; when the identification result is an illegal client, refusing the offload request.

In view of the above descriptions, in the edge computing node system and the method of offloading task between nodes, when the local server is unable to process the offload request of the client device, the local server selects one of the plurality of node servers which is suited to process the offload request as the target server by the classifying procedure and the evaluation of the response signals, and the target server obtains and processes the offload request from the local server so that the offload request is immediately processed without suspending.

The aforementioned description of the present disclosure is merely the outline of the technical solutions of the present disclosure. In order to understand the technical solutions of the present disclosure clearly and to implement the present disclosure according to the content of the specification, the better embodiments of the present disclosure given herein below with accompanying drawings are used to describe the present disclosure in detail.

### BRIEF DESCRIPTION OF DRAWINGS

FIG. 1 depicts a configuration diagram of an edge computing node system according to one embodiment of the present disclosure.

FIG. 2 depicts a functional block diagram of a local server according to one embodiment of the present disclosure.

FIG. 3 depicts a configuration diagram of an edge computing node system according to another embodiment of the present disclosure.

FIG. 4A and FIG. 4B depict flowcharts of a method of offloading task between nodes according to one embodiment of the present disclosure.

FIG. 5 depicts a flowchart of a classification procedure in a method of offloading task between nodes according to one embodiment of the present disclosure.

FIG. 6 depicts a flowchart of selecting a target server from target type node servers in a method of offloading task between nodes according to one embodiment of the present disclosure.

FIG. 7A and FIG. 7B depict flowcharts of a method of offloading task between nodes according to another embodiment of the present disclosure.

FIG. 8 depicts a flowchart of operation of a cloud server according to another embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely a part of the embodiments of the present disclosure and not all embodiments of the present disclosure. Based on the embodiments of the present disclosure, all other embodiments obtained by a person skilled in the art shall fall within the scope of protection of the present disclosure.

It should be noted that the terms “first”, “second”, etc. in the specification and claims of the present disclosure and in the aforementioned accompanying drawings are used to distinguish similar objects and need not be used to describe a particular order or sequence. Furthermore, the terms “comprising” and “having”, and any variation thereof, are intended to encompass a non-exclusive inclusion, for example, a series of steps or units comprising processes, methods, systems, products or equipment need not be limited to those steps or units clearly listed but may include other steps or units not clearly listed or inherent to those processes, methods, products or equipment.

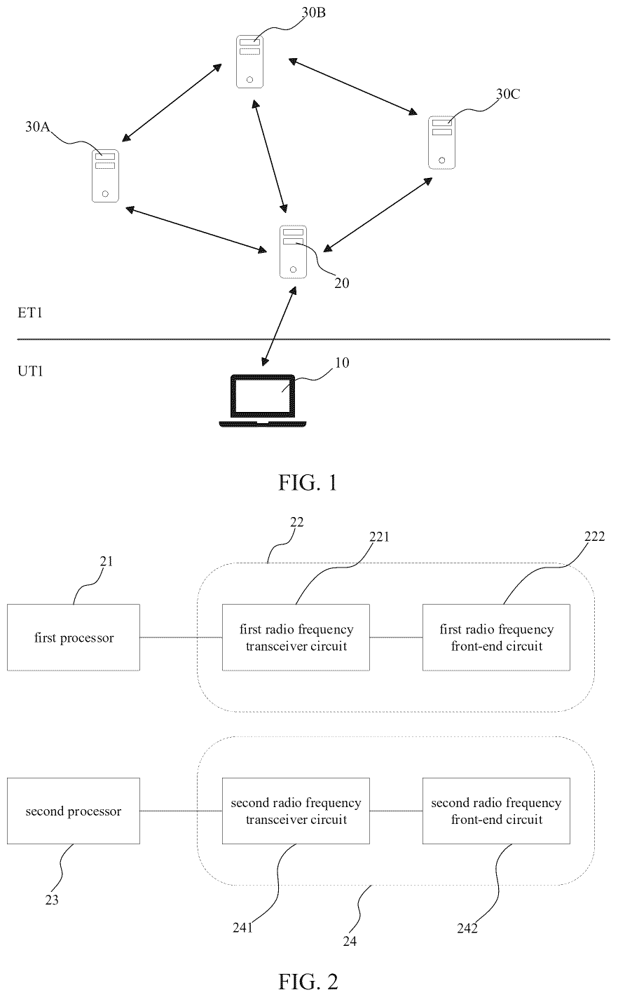

Please refer to FIG. 1, which depicts a configuration diagram of an edge computing node system according to one embodiment of the present disclosure. As shown in FIG. 1, the edge computing network has a client side UT1 and an edge side ET1. The present disclosure proffers an edge computing node system for the edge computing network according to the structure of the edge computing network to help the client device process an offload request. The edge computing node system includes a client device 10, a local server 20 and a plurality of node servers.

The client device 10 is disposed on the client side UT1 and transmits the offload request. The local server 20 is disposed on the edge side ET1 and is connected to the client device 10; specifically, the local server 20 is a local multi-access edge computing (MEC) server and is connected to the client device 10 by 4G networks or 5G networks. It should be noted that the local MEC server is the server created based on the concept of the MEC and is closer to the client device 10 than a remote server to immediately process the offload request of the client device 10 and to assist in the calculation of the client device 10.

The local server 20 ensures a first assistance calculation capability, a first assistance capacity and a first thread, calculates first delay time according to the first assistance calculation capability and the offload request and transmits an ensuring request. Specifically, when receiving the offload request from the client device 10, the local server 20 calculates the first assistance calculation capability thereof, ensures whether there are the first assistance capacity and the first thread in thread stacks thereof (e.g., the thread stack of a first in first out (FIFO) queue) to provide the offload request for use, and calculates the first delay time according to the first assistance calculation capability and the offload request and ensures whether the first delay time lies within a preset time range (i.e., the allowable calculation delay time of the offload request); at the same time, the local server 20 transmits a communication message or a handshake message and the ensuring requests to the plurality of node servers.

It should be noted that the first assistance calculation capability is the remaining calculation capability of the local server 20, the first thread is the thread stacks of the central processing unit (CPU) of the local server 20, the first assistance capacity is the capacity in the thread stacks of the CPU of the local server 20 which is allowed for the offload request to use, and the ensuring request is the message of “ensuring the remaining calculation capability.”

The plurality of node servers are disposed on the edge side ET1 and are wirelessly connected to the local server 20 and the client device 10. Specifically, the plurality of node servers are connected to each other by LoRa (Long Range) networks, are respectively connected to the local server 20 by the LoRa networks and are respectively connected to the client device 10 by the 4G networks or the 5G networks. The plurality of node servers are MEC servers. It should be noted that the difference between the local MEC server and the MEC server: each of the MEC servers corresponds to one electronic device disposed on the client side UT1 instead of the client device 10, and the hardware configuration of the MEC server is similar to the hardware configuration of the local MEC server and would not be repeated again. For example, the number of the plurality of node servers is three, and the three node servers is a first node server 30A, a second node server 30B and a third node server 30C. Each of the first node server 30A, the second node server 30B and the third node server 30C ensures and transmits a second assistance calculation capability and a second assistance capacity to the local server 20 according to the ensuring request, and selectively transmits a second thread to the local server 20. Furthermore, each of the first node server 30A, the second node server 30B and the third node server 30C calculates the second assistance calculation capability thereof, and ensures whether there are the second assistance capacity and the second thread in the thread stacks thereof to provide the offload request for use, and transmits the second assistance calculation capability and the ensuring result about whether there are the second assistance capacity and the second thread in the thread stacks thereof to the local server 20; at the same time, each of the first node server 30A, the second node server 30B and the third node server 30C respectively generates and transmits a response signal to the local server 20 according to the communication message or the handshake message. Afterwards, the local server 20 calculates the second delay time corresponding to the first node server 30A, the second delay time corresponding to the second node server 30B, and the second delay time corresponding to the third node server 30C according to the second assistance calculation capability of the first node server 30A, the second assistance calculation capability of the second node server 30B, the second assistance calculation capability of the third node server 30C, and the offload request.

It should be noted that the second assistance calculation capability is the remaining calculation capability of each node server, the second thread is the thread stacks of the CPU of each node server, and the second assistance capacity is the capacity in the thread stacks of the CPU of each node server which is allowed for the offload request to use.

When evaluating that the first assistance calculation capability, the first assistance capacity or the first thread does not meet the limited condition of the offload request, the local server 20 evaluates the second delay time, the ensuring results about the second assistance capacity and the second thread and the response signals of the first node server 30A, the second node server 30B and the third node server 30C to generate three evaluation results and selects one as a target server from the first node server 30A, the second node server 30B and the third node server 30C according to the three evaluation results, and the target server obtains the offloading message about the offload request from the local server 20 and processes the offload request. The operation details of generating the three evaluation results and selecting the target server will be elaborated in the paragraphs corresponding to a method of offloading task between nodes.

It should be noted that the number of the node servers in the aforementioned embodiment is three but is not used to limit the present disclosure, and the number of the node servers may be four or five. The number of the node servers may be adjusted according to the number of the nodes of the edge computing network and is not limited thereto.

Specifically, the client device 10, the local server 20, the first node server 30A, the second node server 30B and the third node server 30C may be the electronic devices with the CPUs such as a computer, a supercomputer or a mobile terminal device.

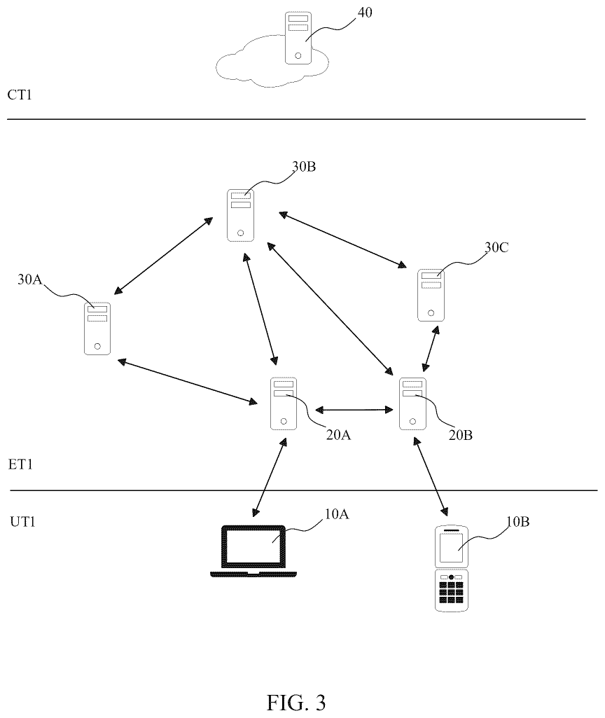

Please refer to FIG. 2, which depicts a functional block diagram of a local server according to one embodiment of the present disclosure. As shown in FIG. 2, the local server 20 includes a first processor 21, a first radio frequency transceiver 22, a second processor 23 and a second radio frequency transceiver 24. The first radio frequency transceiver 22 is the signal transceiver module for the 4G networks or the 5G networks to receive the offload request of the client device 10. The first radio frequency transceiver 22 includes a first radio frequency transceiver circuit 221 and a first radio frequency front-end circuit 222. The first radio frequency transceiver circuit 221 converts baseband signals into radio frequency signals. The first radio frequency front-end circuit 222 processes the radio frequency signals. The first processor 21 is connected to the first radio frequency transceiver 22 and performs an identification procedure on the client device 10 to ensure that the client device 10 is a legal client or an illegal client.

The second radio frequency transceiver 24 is the signal transceiver module for the LoRa networks to transmit the communication message or the handshake message to the first node server 30A, the second node server 30B and the third node server 30C, and the first node server 30A, the second node server 30B and the third node server 30C transmits the three response signals to the second radio frequency transceiver 24 according to the communication message or the handshake message. The second radio frequency transceiver 24 includes a second radio frequency transceiver circuit 241 and a second radio frequency front-end circuit 242. The second radio frequency transceiver circuit 241 converts the baseband signals into the radio frequency signals. The second radio frequency front-end circuit 242 processes the radio frequency signals. The second processor 23 is connected to the second radio frequency transceiver 24 and performs the identification procedure on the first node server 30A, the second node server 30B and the third node server 30C to ensure whether the first node server 30A, the second node server 30B and the third node server 30C are legal servers. Specifically, each of the first node server 30A, the second node server 30B and the third node server 30C may also transmit another communication message or another handshake message to the second radio frequency transceiver 24, and the second processor 23 determines whether the first node server 30A, the second node server 30B and the third node server 30C are the legal servers according to another communication message or another handshake message of each of the first node server 30A, the second node server 30B and the third node server 30C.

It should be noted that, with regard to the configuration of the first node server 30A, the configuration of the second node server 30B and the third node server 30C and the configuration of the local server 20, there is only one difference between each of the configuration of the first node server 30A, the configuration of the second node server 30B and the configuration of the third node server 30C and the configuration of the local server 20 as follows: the local server 20 is closer to the client device 10 than each of the first node server 30A, the second node server 30B and the third node server 30C. In other words, the second radio frequency transceiver 24 of the local server 20, the second radio frequency transceiver of the first node server 30A, the second radio frequency transceiver of the second node server 30B and the second radio frequency transceiver of the third node server 30C are connected to each other by the LoRa networks to implement the transmission of the communication message or the handshake message and the transmission of the three response signals. However, the transmission of the offload request between the client device 10 and the first node server 30A, the transmission of the offload request between the client device 10 and the second node server 30B, the transmission of the offload request between the client device 10 and the third node server 30C, the transmission of the offloading message between the local server 20 and the first node server 30A, the transmission of the offloading message between local server 20 and the second node server 30B, the transmission of the offloading message between the local server 20 and the third node server 30C are implemented by the 4G networks or the 5G networks. In other words, the client device 10 transmits the offload request to the first radio frequency transceiver of the first node server 30A, the first radio frequency transceiver of the second node server 30B or the first radio frequency transceiver of the third node server 30C, and the first radio frequency transceiver of the local server 20 by the 4G networks or the 5G networks, and the first radio frequency transceiver of the local server 20 transmits the offloading message to the first radio frequency transceiver of the first node server 30A, the first radio frequency transceiver of the second node server 30B or the first radio frequency transceiver of the third node server 30C.

If the transmission of the communication message or the handshake message between the local server 20 and each of the first node server 30A, the second node server 30B and the third node server 30C is implemented by Wifi, the WiFi would consume a large amount of electrical power, and the transmission distance of the WiFi is not long enough. If the transmission of the communication message or the handshake message between the local server 20 and each of the first node server 30A, the second node server 30B and the third node server 30C is implemented by Bluetooth (BT), the BT has an advantage of low power consumption, but the transmission distance of the BT is still not long enough. In contrast, the transmission of the communication message or the handshake message between the local server 20 and each of the first node server 30A, the second node server 30B and the third node server 30C in the present disclosure is implemented by the LoRa networks, and the LoRa networks has the advantages of the low power consumption and the longer transmission distance. Although the transmission rate of the LoRa networks is low, the transmission rate of the LoRa networks is adequate for the transmission of the communication message or the handshake message between the local server 20 and each of the first node server 30A, the second node server 30B and the third node server 30C.

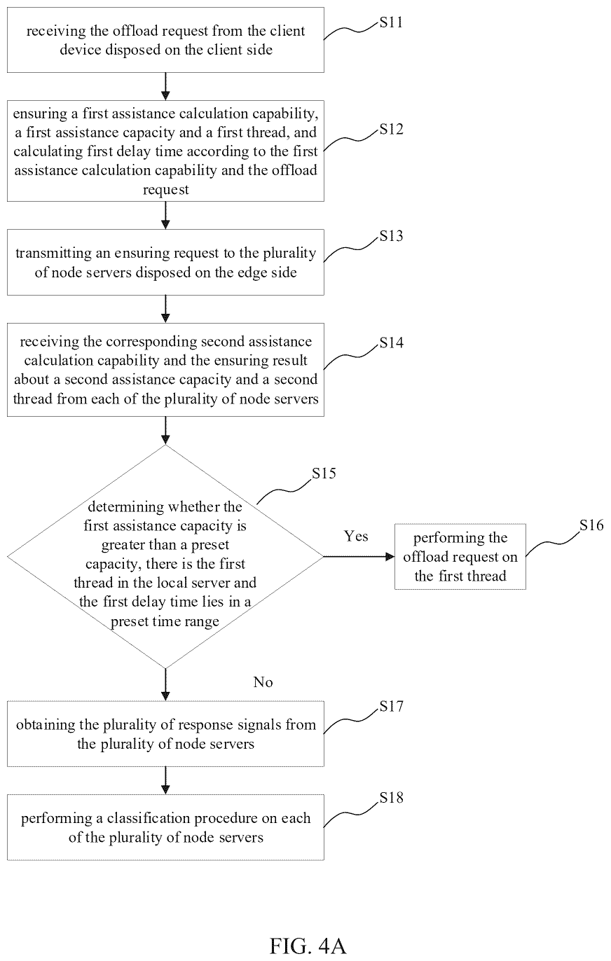

Please refer to FIG. 3, which depicts a configuration diagram of an edge computing node system according to another embodiment of the present disclosure. As shown in FIG. 3, the edge computing network includes the client side UT1, the edge side ET1 and a cloud side CTI, and the edge computing node system includes the first client device 10A, a second client device 10B, the first local server 20A, a second local server 20B, the first node server 30A, the second node server 30B, the third node server 30C and a cloud server 40. The configurations of the client side UT1 and the edge side ET1 are the same as the configurations of the client side UT1 and the edge side ET1 shown in FIG. 1 and would not be repeated again; the configurations of the first client device 10A, the first local server 20A, the first node server 30A, the second node server 30B and the third node server 30C are the same as the configurations of the client device 10, the local server 20, the first node server 30A, the second node server 30B and the third node server 30C shown in FIG. 1 and would not be repeated again.

In the present embodiment, the number of the client devices is two, and the two client devices are the first client device 10A and the second client device 10B; the number of the local servers is two, and the two local servers are the first local server 20A and the second local server 20B. Correspondingly, the offload request, the offloading message and the ensuring request corresponding to the first client device 10A and the first local server 20A are a first offload request, a first offloading message and a first ensuring request, and the offload request, the offloading message and the ensuring request corresponding to the second client device 10B and second local server 20B are a second offload request, a second offloading message and a second ensuring request.

The first client device 10A is connected to the first local server 20A, and the second client device 10B is connected to the second local server 20B, and the first local server 20A is connected to the second local server 20B. Specifically, the first client device 10A is connected to the first local server 20A by the 4G networks or the 5G networks to transmit the first offload request to the first local server 20A. The second client device 10B is connected to the second local server 20B by the 4G networks or the 5G networks to transmit the second offload request to the second local server 20B. The first local server 20A is connected to the second local server 20B by the LoRa networks to transmit the communication message or the handshake message. The cloud server 40 is disposed on the cloud side and is connected to the first local server 20A and the second local server 20B.

It should be noted that the calculation and the evaluation of the first delay time and the ensuring of the first thread and the first assistance capacity of the first local server 20A and the second local server 20B is the same as the calculation and the evaluation of the first delay time and the ensuring of the first thread and the first assistance capacity of the local server 20 shown in FIG. 1 and would not be repeated again; the calculation of the second assistance calculation capability and the generation of the ensuring result about the second assistance capacity and the second thread for the first ensuring request and the second ensuring request performed by each of the first node server 30A, the second node server 30B and the third node server 30C are the same as the calculation of the second assistance calculation capability and the generation of the ensuring result about the second assistance capacity and the second thread for the ensuring request performed by each of the first node server 30A, the second node server 30B and the third node server 30C and would not be repeated again.

When evaluating that the first assistance calculation capability, the first assistance capacity or the first thread does not meet the limited condition of the first offload request, the first local server 20A evaluates the second delay time, the ensuring results about the second assistance capacity and the second thread and the response signals of the first node server 30A, the second node server 30B and the third node server 30C to generate three evaluation results and selects one as the target server from the first node server 30A, the second node server 30B and the third node server 30C according to the three evaluation results, and the target server obtains the offloading message about the first offload request from the first local server 20A and processes the first offload request. When determining that the first node server 30A, the second node server 30B and the third node server 30C are not suited to serve as the target server, the first local server 20A performs a real-time calculation request determination procedure on the first offload request and generates and transmits the determination result about the real-time calculation request and an assistance message to the cloud server 40, and the cloud server 40 selectively processes the first offload request according to the determination result about the real-time calculation request.

When evaluating that the first assistance calculation capability, the first assistance capacity or the first thread does not meet the limited condition of the second offload request, the second local server 20B evaluates the second delay time, the ensuring results about the second assistance capacity and the second thread and the response signals of the first node server 30A, the second node server 30B and the third node server 30C to generate three evaluation results and selects one as the target server from the first node server 30A, the second node server 30B and the third node server 30C according to the three evaluation results, and the target server obtains the offloading message about the second offload request from the second local server 20B and processes the second offload request. When determining that the first node server 30A, the second node server 30B and the third node server 30C are not suited to serve as the target server, the second local server 20B performs the real-time calculation request determination procedure on the second offload request and generates and transmits the determination result about the real-time calculation request and the assistance message to the cloud server 40, and the cloud server 40 selectively processes the second offload request according to the determination result about the real-time calculation request.

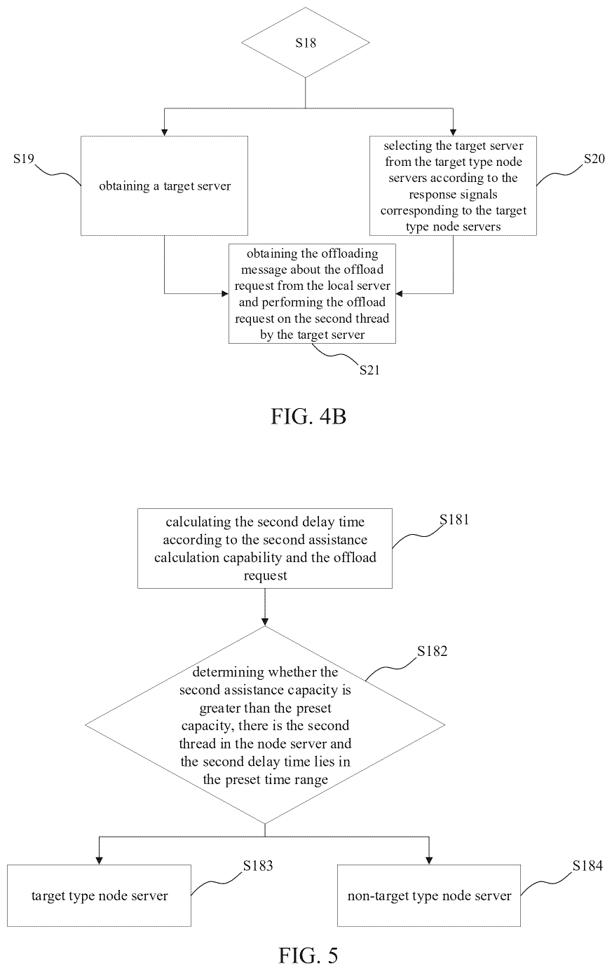

Please refer to FIG. 4A and FIG. 4B, which depict flowcharts of a method of offloading task between nodes according to one embodiment of the present disclosure. As shown in FIG. 4A and FIG. 4B, the method of offloading task between nodes includes step S11˜step S21. The method of offloading task between nodes may be applicable to the edge computing node systems shown in FIG. 1 and FIG. 3 but is not limited thereto. For example, the step S11˜step S21 would be explained by the edge computing node system shown in FIG. 1 and the local server 20 shown in FIG. 2 as follows.
Step S11: receiving the offload request from the client device 10 disposed on the client side UT1. As described above, the local server 20 disposed on the edge side ET1 receives the offload request from the client device 10.
Step S12: ensuring a first assistance calculation capability, a first assistance capacity and a first thread, and calculating first delay time according to the first assistance calculation capability and the offload request. As described above, when receiving the offload request, the local server 20 calculates the first assistance calculation capability thereof and calculates the first delay time according to the first assistance calculation capability and the offload request and ensures whether there are the first assistance capacity and the first thread in the thread stacks thereof to provide the offload request for use.
Step S13: transmitting an ensuring request to the plurality of node servers disposed on the edge side ET1. For example, the number of the plurality of node servers is three, the three node servers are the first node server 30A, the second node server 30B and the third node server 30C, and the details of the step S14˜step S21 would be exemplarily explained by the first node server 30A, the second node server 30B and the third node server 30C. The second radio frequency transceiver 24 of the local server 20 transmits the ensuring request to the first node server 30A, the second node server 30B and the third node server 30C; it should be noted that the ensuring request is the command which indicates each of the first node server 30A, the second node server 30B and the third node server 30C to ensure the second assistance calculation capability, the second assistance capacity and the second thread thereof. In addition, in the step S13, the second radio frequency transceiver 24 of the local server 20 also transmits the communication message or the handshake message to the first node server 30A, the second node server 30B and the third node server 30C. In one embodied aspect, the step S12 and the step S13 are synchronously performed. In another embodied aspect, the step S12 and the step S13 are separately performed.
Step S14: receiving the corresponding second assistance calculation capability and the ensuring result about a second assistance capacity and a second thread from each of the plurality of node servers. Specifically, each of the first node server 30A, the second node server 30B and the third node server 30C calculates the second assistance calculation capability thereof according to the ensuring request and ensures whether there are the second assistance capacity and the second thread in the thread stacks thereof to provide the offload request for use in order to generate the ensuring result. Afterwards, the first node server 30A, the second node server 30B and the third node server 30C transmit the three second assistance calculation capabilities and the three ensuring results to the local server 20.
Step S15: determining whether the first assistance capacity is greater than a preset capacity, there is the first thread in the local server 20 and the first delay time lies within a preset time range. Specifically, the local server 20 ensures whether there is the first assistance capacity in the thread stacks thereof and the first assistance capacity is greater than the preset capacity (e.g., the 40% capacity of the CPU thread stacks may provide the offload request for use), ensures whether to arrange the first thread to provide the offload request for use and determines whether the first delay time lies between an upper threshold value and a lower threshold value. It should be noted that the preset capacity is the minimum capacity of the CPU thread stacks for providing the offload request to use defined by the offload request, and the preset time range is the allowable calculation delay time of the offload request; the preset capacity and the preset time range would change due to the limited condition of the offload request, and the values of the preset capacity and the preset time range would not be limited herein.

When ensuring that there is the first assistance capacity greater than the preset capacity in the thread stacks of the local server 20, the first thread can be arranged to provide the offload request to use, and the first delay time lies between the upper threshold value and the lower threshold value, the local server 20 subsequently preforms the step S16. When ensuring that there is not the first assistance capacity greater than the preset capacity in the thread stacks of the local server 20, the first thread cannot be arranged to provide the offload request to use, or the first delay time does not lie between the upper threshold value and the lower threshold value, the local server 20 subsequently preforms the step S17.
Step S16: performing the offload request on the first thread. Specifically, the local server 20 performs the offload request on the first thread.
Step S17: obtaining the plurality of response signals from the plurality of node servers. Specifically, each of the first node server 30A, the second node server 30B and the third node server 30C generates and transmits the response signal according to the communication message or the handshake message, and the local server 20 obtains the three response signals from the first node server 30A, the second node server 30B and the third node server 30C.
Step S18: performing a classification procedure on each of the plurality of node servers. Specifically, the local server 20 performs the classification procedure according to the three second assistance calculation capabilities and the three ensuring results corresponding to the first node server 30A, the second node server 30B and the third node server 30C to classify the first node server 30A, the second node server 30B and the third node server 30C as a target type node server or a non-target type node server.

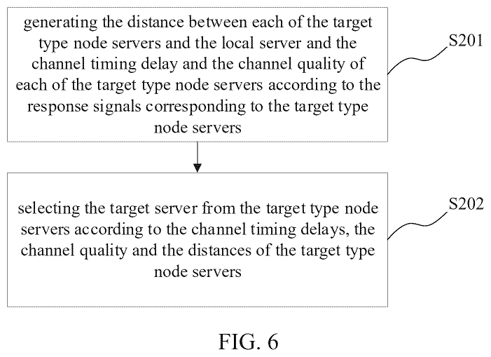

Furthermore, the local server 20 calculates the three second delay time according to the three second assistance calculation capabilities corresponding to the first node server 30A, the second node server 30B and the third node server 30C and compares the three second delay time and the three ensuring results with the preset capacity and the preset time range to classify the first node server 30A, the second node server 30B and the third node server 30C as the target type node server or the non-target type node server. Please further refer to FIG. 5, which depicts a flowchart of a classification procedure in a method of offloading task between nodes according to one embodiment of the present disclosure. As shown in FIG. 5, the classification procedure includes step S181˜step S184. For example, the step S181˜step S184 would be explained by the first node server 30A, and the classification procedure performed on the second node server 30B and the classification procedure performed on the third node server 30C are the same as the classification procedure performed on the first node server 30A and would not be repeated again.
Step S181: calculating the second delay time according to the second assistance calculation capability and the offload request. Specifically, the local server 20 calculates the second delay time according to the second assistance calculation capability corresponding to the first node server 30A and the amount of data of the offload request.
Step S182: determining whether the second assistance capacity is greater than the preset capacity, there is the second thread in the node server and the second delay time lies within a preset time range. Specifically, the local server 20 ensures whether there is the second assistance capacity in the thread stacks of the first node server 30A and the second assistance capacity is greater than the preset capacity from the ensuring result corresponding to the first node server 30A, ensures whether the first node server 30A can arrange the second thread to provide the offload request for use from the ensuring result corresponding to the first node server 30A and determines whether the second delay time lies between the upper threshold value and the lower threshold value.

When ensuring that there is the second assistance capacity greater than the preset capacity in the thread stacks of the first node server 30A, the second thread can be arranged to provide the offload request to use by the first node server 30A, and the second delay time lies between the upper threshold value and the lower threshold value, the local server 20 subsequently preforms the step S183. When ensuring that there is not the second assistance capacity greater than the preset capacity in the thread stacks of the first node server 30A, the second thread cannot be arranged to provide the offload request to use by the first node server 30A, or the second delay time does not lie between the upper threshold value and the lower threshold value, the local server 20 subsequently preforms the step S184.
Step S183: target type node server. Specifically, the local server 20 determines that the first node server 30A belongs to the target type node server.
Step S184: non-target type node server. Specifically, the local server 20 determines that the first node server 30A belongs to the non-target type node server.

When determining that one of the first node server 30A, the second node server 30B and the third node server 30C belongs to the target type node server, and for example, the first node server 30A belongs to the target type node server and the second node server 30B and the third node server 30C belong to the non-target type node server, the local server 20 subsequently preforms the step S19. When determining that two of the first node server 30A, the second node server 30B and the third node server 30C belong to the target type node server, and for example, the first node server 30A and the second node server 30B belong to the target type node server and the third node server 30C belongs to the non-target type node server, the local server 20 subsequently preforms the step S20. When determining that the first node server 30A, the second node server 30B and the third node server 30C all belong to the target type node server, the local server 20 subsequently preforms the step S20.
Step S19: obtaining a target server. Specifically, the local server 20 obtains the first node server 30A as the target server.
Step S20: selecting the target server from the target type node servers according to the response signals corresponding to the target type node servers. In the situation that the two node servers belong to the target server, the local server 20 selects one of the first node server 30A and the second node server 30B as the target server according to the two response signals corresponding to the first node server 30A and the second node server 30B. Specifically, the local server 20 assesses the channel condition between the local server 20 and the first node server 30A and the channel condition between the local server 20 and the second node server 30B according to the two response signals corresponding to the first node server 30A and the second node server 30B and selects one of the first node server 30A and the second node server 30B as the target server according the two channel conditions corresponding to the first node server 30A and the second node server 30B.

In the situation that the three node servers belong to the target server, the local server 20 selects one as the target server from the first node server 30A, the second node server 30B and the third node server 30C according to the three response signals corresponding to the first node server 30A, the second node server 30B and the third node server 30C. Specifically, the local server 20 assesses the channel condition between the local server 20 and the first node server 30A, the channel condition between the local server 20 and the second node server 30B and the channel condition between the local server 20 and the third node server 30C according to the three response signals corresponding to the first node server 30A, the second node server 30B and the third node server 30C and selects one as the target server from the first node server 30A, the second node server 30B and the third node server 30C according to the three channel conditions corresponding to the first node server 30A, the second node server 30B and the third node server 30C.

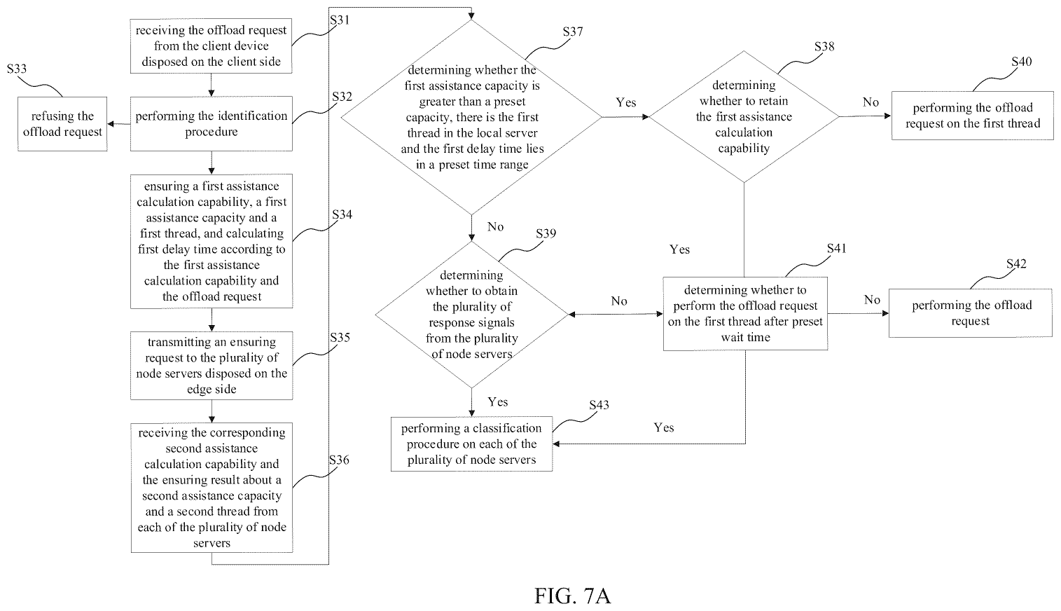

Please further refer to FIG. 6, which depicts a flowchart of selecting a target server from target type node servers in a method of offloading task between nodes according to one embodiment of the present disclosure. As shown in FIG. 6, selecting the target server from the target type node servers includes step S201 and step S202.
Step S201: generating the distance between each of the target type node servers and the local server and the channel timing delay and the channel quality of each of the target type node servers according to the response signals corresponding to the target type node servers. In the situation that the two node servers belong to the target server, the local server 20 generates the distance between the first node server 30A and the local server 20, the channel timing delay and the channel quality of the first node server 30A, the distance between the second node server 30B and the local server 20 and the channel timing delay and the channel quality of the second node server 30B according to the two response signals corresponding to the first node server 30A and the second node server 30B. It should be noted that the channel quality of the first node server 30A includes the link rate and the signal-to-noise ratio (SNR) between the first node server 30A and the client device 10 and the channel quality of the second node server 30B includes the link rate and the SNR between the second node server 30B and the client device 10.

In the situation that the three node servers belong to the target server, the local server 20 generates the distance between the first node server 30A and the local server 20, the channel timing delay and the channel quality of the first node server 30A, the distance between the second node server 30B and the local server 20, the channel timing delay and the channel quality of the second node server 30B, the distance between the third node server 30C and the local server 20 and the channel timing delay and the channel quality of the third node server 30C according to the three response signals corresponding to the first node server 30A, the second node server 30B and the third node server 30C. It should be noted that the channel timing delay and the channel quality of the third node server 30C includes the link rate and the SNR between third node server 30C and the client device 10 and the channel quality of the first node server 30A and the channel quality of the second node server 30B have been described in the foregoing paragraph and would not be repeated again.
Step S202: selecting the target server from the target type node servers according to the channel timing delays, the channel quality and the distances of the target type node servers. Specifically, the local server 20 regards the shortest distance, the minimum channel timing delay and the best channel quality as a determination standard. In the situation that the two node servers belong to the target server, for example, the local server 20 determines that the distance between the second node server 30B and the local server 20 is shorter than the distance between the first node server 30A and the local server 20, the channel timing delay of the second node server 30B is less than the channel timing delay of the first node server 30A and the channel quality of the second node server 30B is better than the channel quality of the first node server 30A and selects the second node server 30B as the target server. In the situation that the three node servers belong to the target server, for example, the local server 20 determines that the distance between the third node server 30C and the local server 20 is the shortest, the channel timing delay of the third node server 30C is the minimum and the channel quality of the third node server 30C is the best and selects the third node server 30C as the target server.
Step S21: obtaining the offloading message about the offload request from the local server 20 and performing the offload request on the second thread by the target server. In the situation that the one node server belongs to the target type node server, the first node server 30A serves as the target server, obtains the offloading message about the offload request from the local server 20 and performs the offload request on the second thread. In the situation that the two node servers belong to the target type node server, the second node server 30B serves as the target server, obtains the offloading message about the offload request from the local server 20 and performs the offload request on the second thread. In the situation that the three node servers belong to the target server, the third node server 30C serves as the target server, obtains the offloading message about the offload request from the local server 20 and performs the offload request on the second thread. It should be noted that the offloading message is the message that the local server 20 asks the target server to assist in processing the offload request.

In the present embodiment of the method of offloading task between nodes, when the local server is unable to process the offload request of the client device, the local server classifies the plurality of node servers on the edge side to select at least one target type node server suitable for the offload request and assesses the distance, the channel timing delay and the channel quality of the at least one target type node server to select one as the target server from the at least one target type node server, and the target server assists in processing the offload request of the client device so that the offload request is immediately processed without suspending.

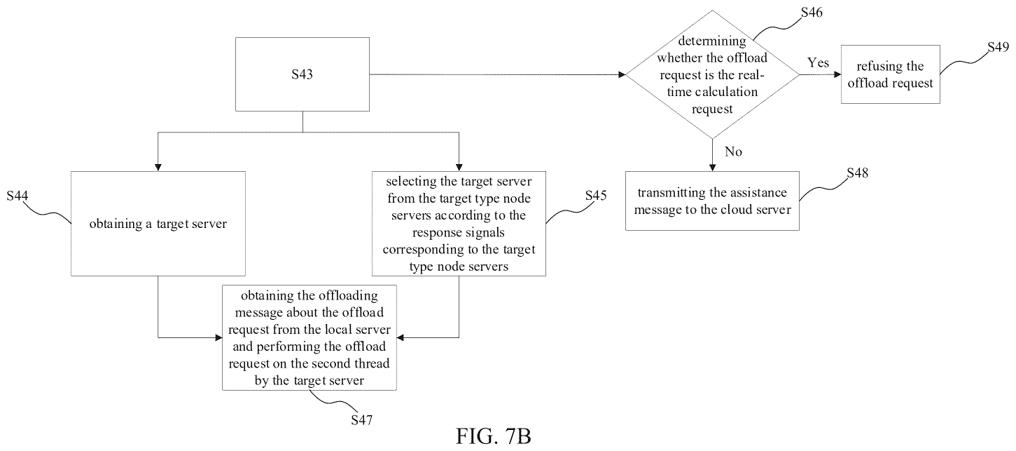

Please refer to FIG. 7A and FIG. 7B, which depict flowcharts of a method of offloading task between nodes according to another embodiment of the present disclosure. As shown in FIG. 7A and FIG. 7B, the method of offloading task between nodes includes step S31˜step S49. The step S31 and the step S34˜step S37 are the same as the step S11˜step S15 and would not be repeated again, and the step S43 and the step S44˜step S47 are the same as the step S17˜step S21 and would not be repeated again. The step S32, the step S33, the step S38˜step S42, the step S46, the step S48 and the step S49 would be explained by the edge computing node system shown in FIG. 3. The step S32 is to identify whether the client device is a legal device; the step S38˜step S40 are to determine whether to retain the first assistance calculation capability of the local server to select whether to perform the offload request on the local server; the step S39, the step S41 and the step S42 are to determine whether to receive the response signals of the plurality of node servers and to select whether to perform the offload request after preset wait time; the step S46, the step S48 and the step S49 are to selectively perform the offload request according to the type of the offload request when each of the plurality of node servers is determined to belong to the non-target type node server.

Furthermore, the operation of processing the first offload request, the first offloading message and the first ensuring request by the first local server 20A is the same as the operation of processing the second offload request, the second offloading message and the second ensuring request by the second local server 20B, and the step S32, the step S33, the step S38˜step S42, the step S46, the step S48 and the step S49 would be explained by the configuration with the first local server 20A, the first client device 10A, the first node server 30A, the second node server 30B, the third node server 30C and the cloud server 40 herein.
Step S32: performing the identification procedure. Specifically, when receiving the first offload request of the first client device 10A, the first local server 20A performs the identification procedure on the identification code of the first client device 10A to compare the identification code stored on the first local server 20A with the identification code of the first client device 10A, thus generating an identification result. When the identification code stored on the first local server 20A is consistent with the identification code of the first client device 10A, the identification result corresponding to the first client device 10A is the legal client, and the first local server 20A subsequently performs the step S34. When the identification code stored on the first local server 20A is not consistent with the identification code of the first client device 10A, the identification result corresponding to the first client device 10A is the illegal client, and the first local server 20A subsequently performs the step S33.
Step S33: refusing the offload request. Specifically, when the identification result corresponding to the first client device 10A is the illegal client, the first local server 20A refuses the first offload request of the first client device 10.
Step S38: determining whether to retain the first assistance calculation capability. Specifically, the first local server 20A determines whether to retain the first assistance calculation capability according to scheduled tasks and calculation capability thereof. Furthermore, when the numerous scheduled tasks cause that the first local server 20A is in a full load state, the calculation capability of the first local server 20A is unable to process so numerous scheduled tasks, and the first local server 20A needs to retain the first assistance calculation capability and subsequently performs the step S39. When the less scheduled tasks cause that the first local server 20A is in an idle state, the calculation capability of the first local server 20A is still able to process the scheduled tasks, and the first local server 20A does not need to retain the first assistance calculation capability and subsequently performs the step S40.
Step S39: determining whether to obtain the plurality of response signals from the plurality of node servers. Specifically, the first node server 30A, the second node server 30B and the third node server 30C selectively generate and transmit the plurality of response signals to the first local server 20A according to the communication message or the handshake message, and the first local server 20A continues to wait the transmission of at least one response signal or subsequently performs the classification procedure on the node server which transmits the response signal according to the results of transmission the response signals by the first node server 30A, the second node server 30B and the third node server 30C.

When determining that the response signal is received from at least one of the first node server 30A, the second node server 30B and the third node server 30C, the first local server 20A subsequently performs the step S43. When determining that the three response signals are not received from the first node server 30A, the second node server 30B and the third node server 30C, the first local server 20A subsequently performs the step S41.
Step S40: performing the offload request on the first thread. Specifically, the first local server 20A performs the first offload request on the first thread.
Step S41: determining whether to perform the offload request on the first thread after preset wait time. Specifically, after the preset wait time, the first local server 20A receives the response signal from at least one of the first node server 30A, the second node server 30B and the third node server 30C and subsequently performs the step S43. After the preset wait time, the first local server 20A does not still receive the three response signals from the first node server 30A, the second node server 30B and the third node server 30C and subsequently performs the step S42.
Step S42: performing the offload request. Specifically, the first local server 20A still performs the first offload request.

When determining that the response signal is received from the first node server 30A or the second node server 30B, and both the first node server 30A and the second node server 30B are target type node server, the first local server 20A selects the first node server 30A or the second node server 30B as the target server. When determining that the response signal is received from the third node server 30C, and both the first node server 30A and the second node server 30B are target type node server, the first local server 20A goes back to the step S39 and redetermines whether to receive the response signal from at least one of the first node server 30A, the second node server 30B and the third node server 30C.

When determining that the response signal is received from one of the first node server 30A, the second node server 30B and the third node server 30C, and all the first node server 30A, the second node server 30B and the third node server 30C are target type node server, the first local server 20A selects the node server corresponding to the response signal as the target server. For example, when determining that the response signal is received from the third node server 30C, and all the first node server 30A, the second node server 30B and the third node server 30C are target type node server, the first local server 20A selects the third node server 30C as the target server.

When determining that the two response signals are received from two of the first node server 30A, the second node server 30B and the third node server 30C, and all the first node server 30A, the second node server 30B and the third node server 30C are target type node server, the first local server 20A performs the step S45 on the node servers corresponding to the two response signals. For example, when determining that the two response signals are received from the second node server 30B and the third node server 30C, and all the first node server 30A, the second node server 30B and the third node server 30C are target type node server, the first local server 20A performs the step S45 on the second node server 30B and the third node server 30C to select one of the second node server 30B and the third node server 30C as the target server.

It should be noted that, when the first local server 20A and the second local server 20B select the same node server as the target server to perform the first offload request and the second offload request, the foregoing node server performs the first offload request and the second offload request based on the order of priority of the first offload request and the second offload request. For example, when both the first local server 20A and the second local server 20B select the third node server 30C as the target server, the first offload request is an urgent task and has the priority, the second offload request is a general task and does not have the priority, and the third node server 30C first performs the first offload request on the second thread and then performs the second offload request.

In the step S43, when determining that all the first node server 30A, the second node server 30B and the third node server 30C belong to the non-target type node server, the first local server 20A evaluates that all the first node server 30A, the second node server 30B and the third node server 30C are unable to process the first offload request, and the first local server 20A subsequently performs the step S46.
Step S46: determining whether the offload request is the real-time calculation request. Specifically, the first node server 30A determines whether the first offload request is the real-time calculation request according to the allowable message packet loss rate and the packet type of the first offload request.

When the allowable message packet loss rate of the first offload request is less than a preset value (e.g., 5%), and the first offload request belongs to a video conference packet, the first node server 30A determines that the first offload request is the real-time calculation request and subsequently performs the step S49. When the allowable message packet loss rate of the first offload request is not less than a preset value (e.g., 5%), and the first offload request does not belong to the video conference packet, the first node server 30A determines that the first offload request is not the real-time calculation request and subsequently performs the step S48.
S48: transmitting the assistance message to the cloud server 40. Specifically, the first local server 20A transmits the assistance message and the first offload request to the cloud server 40.
S49: refusing the offload request. Specifically, the first local server 20A refuses the first offload request and transmits the assistance message to the cloud server 40.

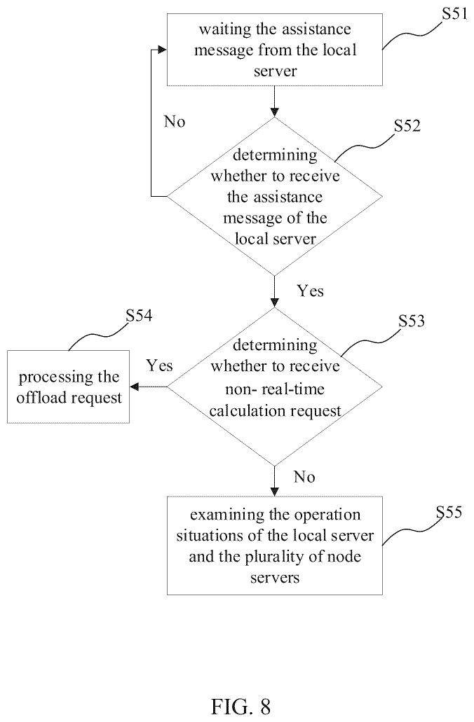

The following paragraph would introduce the operation of selectively performing the first offload request according to the determination result of the real-time calculation request by the cloud server 40. Please refer to FIG. 8, which depicts a flowchart of operation of a cloud server according to another embodiment of the present disclosure. As shown in FIG. 8, the operation steps of the cloud server 40 includes step S51˜step S55.
Step S51: waiting to receive the assistance message from the local server. Specifically, the cloud server 40 waits to receive the assistance message from the first local server 20A.
Step S52: determining whether to receive the assistance message of the local server. Specifically, when receiving the assistance message of the first local server 20A, the cloud server 40 subsequently performs the step S53. When not receiving the assistance message of the first local server 20A, the cloud server 40 goes back to the step S53.
Step S53: determining whether to receive non-real-time calculation request. Specifically, when the first local server 20A determines that the first offload request is the real-time calculation request, the cloud server 40 does not receive the non-real-time calculation request of the first local server 20A and subsequently performs the step S55. When the first local server 20A determines that the first offload request is the non-real-time calculation request, the cloud server 40 receives the non-real-time calculation request of the first local server 20A and subsequently performs the step S54.
Step S54: processing the offload request. Specifically, the cloud server 40 processes the first offload request.
Step S55: examining the operation situations of the local server and the plurality of node servers. Specifically, the cloud server 40 examines the operation situations of the first client device 10A, the first local server 20A, the first node server 30A, the second node server 30B and the third node server 30C.

The operation performed by the cloud server 40 according to the operation situation of the server would be explained by the first local server 20A as follows, and the operation performed by the cloud server 40 according to the operation situations of the first client device 10A, the first node server 30A, the second node server 30B and third node server 30C is the same as the operation performed by the cloud server 40 according to the operation situation of the first local server 20A and would not be repeated again.

When the calculation capability of the first local server 20A is insufficient and the first local server 20A is in the idle state, the cloud server 40 marks the first local server 20A as a sleep state and asks the first local server 20A to shut down. When the calculation capability of the first local server 20A is insufficient and remains less than 10%, the cloud server 40 marks the first local server 20A as the full load state. When the calculation capability of the first local server 20A is insufficient and remains 10%˜30%, the cloud server 40 marks the first local server 20A as not receiving the real-time calculation request. When the calculation capability of the first local server 20A is insufficient and the response rate of the first local server 20A is slow, the cloud server 40 enforces a reboot on the first local server 20A.

In the present embodiment of the method of offloading task between nodes, when the local server evaluates that the plurality of node servers are unable to process the offload request, the local server asks the cloud server to assist in processing the offload request. When the offload request is the non-real-time calculation request, the cloud server assists in processing the offload request. When the offload request is the real-time calculation request, the cloud server examines the operation situations of the local server, the client device and the plurality of node servers and classifies them or asks them to shut down accordingly to achieve electrical power saving.

In view of the above descriptions, in the edge computing node system and the method of offloading task between nodes, when the local server is unable to process the offload request of the client device, the local server selects one of the plurality of node servers which is suited to process the offload request as the target server by the classifying procedure and the evaluation of the response signals, and the target server obtains and processes the offload request from the local server so that the offload request is immediately processed without suspending.

What is claimed is:

1. An edge computing node system for an edge computing network with a client side and an edge side comprising:
a client device disposed on the client side and transmitting an offload request;
a local server disposed on the edge side and connected to the client device, ensuring a first assistance calculation capability, a first assistance capacity and a first thread, calculating first delay time according to the first assistance calculation capability and the offload request and transmitting an ensuring request; and
a plurality of node servers disposed on the edge side and wirelessly connected to the local server and the client device respectively, wherein each of the plurality of node servers ensures and transmits a second assistance calculation capability and an ensuring result about a second assistance capacity and a second thread to the local server according to the ensuring request;
wherein when the first assistance capacity is not greater than a preset capacity, the local server does not have the first thread or the first delay time does not lie within a preset time range, and the local server obtains a plurality of response signals from the plurality of node servers, the local server performs a classification procedure on each of the plurality of node servers, and the classification procedure comprising:
calculating second delay time according to the second assistance calculation capability and the offload request; and
when determining that the node server has the second thread, the second assistance capacity is greater than the preset capacity and the second delay time lies within the preset time range, classifying the node server as a target type node server;
wherein when a number of the target type node server is at least one, the local server selects a target server from the at least one target type node server according to the response signal corresponding to the at least one target type node server, and the target server obtains an offloading message about the offload request from the local server and performs the offload request on the second thread.

2. The edge computing node system according to claim 1, wherein the local server is a local MEC server, and the plurality of node servers are MEC servers.

3. The edge computing node system according to claim 1, wherein when the number of the target type node servers are multiple, selecting the target server from the target type node servers according to the response signals corresponding to the target type node servers performed by the local server comprising:
generating a distance between each of the target type node servers and the local server and a channel timing delay and channel quality of each of the target type node servers according to the response signals corresponding to the target type node servers; and
selecting the target server from the target type node servers according to the channel timing delays, the channel quality and the distances of the target type node servers.

4. The edge computing node system according to claim 1, wherein when the first assistance capacity is greater than the preset capacity, the local server has the first thread, and the first delay time lies within the preset time range, the local server determines whether to retain the first assistance calculation capability;
when determining to retain the first assistance calculation capability and obtaining the response signal from at least one of the plurality of node servers, the local server performs the classification procedure on the node server corresponding to the response signal;
when determining not to retain the first assistance calculation capability, the local server performs the offload request on the first thread.

5. The edge computing node system according to claim 4, wherein when determining to retain the first assistance calculation capability and not obtaining the response signals from the plurality of node servers after preset wait time, the local server performs the offload request.

6. The edge computing node system according to claim 1, wherein when the first assistance capacity is not greater than the preset capacity, the local server does not have the first thread, the first delay time does not lie within the preset time range, and not obtaining the plurality of response signals from the plurality of node servers after preset wait time, the local server performs the offload request.

7. The edge computing node system according to claim 1, wherein the classification procedure further comprising:
when determining that the node server does not have the second thread, the second assistance capacity is not greater than the preset capacity or the second delay time does not lie within the preset time range, classifying the node server as a non-target type node server.

8. The edge computing node system according to claim 7, wherein when the plurality of node servers belong to the non-target type node server, the local server determines whether the offload request is a real-time calculation request.

9. The edge computing node system according to claim 8, wherein the edge computing network further comprises a cloud side, the edge computing node system further comprises a cloud server, and the cloud server is disposed on the cloud side and is connected to the local server;
when determining that offload request is the real-time calculation request, the local server refuses the offload request and transmits an assistance message to the cloud server, and the cloud server examines operation situations of the local server and the plurality of node servers;
when determining that offload request is not the real-time calculation request, the local server transmits the offload request and the assistance message to the cloud server, and the cloud server processes the offload request.

10. The edge computing node system according to claim 1, wherein the local server performs an identification procedure on the client device to generate an identification result when receiving the offload request;
when the identification result is a legal client, the local server ensures the first assistance calculation capability, the first assistance capacity and the first thread, and calculates the first delay time according to the first assistance calculation capability and the offload request and transmits the ensuring request to the plurality of node servers;
when the identification result is an illegal client, the local server refuses the offload request.

11. The edge computing node system according to claim 10, wherein the local server comprising:
a first radio frequency transceiver receiving the offload request;
a first processor connected to the first radio frequency transceiver and performing the identification procedure on the client device;
a second radio frequency transceiver transmitting a communication message or a handshake message to the plurality of node servers, wherein the plurality of node servers transmit the plurality of response signals to the second radio frequency transceiver according to the communication message or the handshake message;
a second processor connected to the second radio frequency transceiver and performing the identification procedure on each of the plurality of node servers.

12. The edge computing node system according to claim 10, wherein the plurality of node servers are connected with each other by LoRa networks, the second radio frequency transceiver transmits the communication message or the handshake message to the plurality of node servers by the LoRa networks, and the plurality of node servers transmits the plurality of response signals to the second radio frequency transceiver by the LoRa networks according to the communication message or the handshake message.

13. A method of offloading task between nodes for an edge computing network with a client side and an edge side, and the method of offloading task between nodes performed by a local server disposed on the edge side comprising:
receiving an offload request from a client device disposed on the client side;
ensuring a first assistance calculation capability, a first assistance capacity and a first thread, and calculating first delay time according to the first assistance calculation capability and the offload request;
transmitting an ensuring request to a plurality of node servers disposed on the edge side;
receiving a corresponding second assistance calculation capability and an ensuring result about a second assistance capacity and a second thread from each of the plurality of node servers;
when the first assistance capacity is not greater than a preset capacity, there is not the first thread in the local server or the first delay time does not lie within a preset time range, and obtaining a plurality of response signals from the plurality of node servers, performing a classification procedure on each of the plurality of node servers, and the classification procedure comprising:
calculating second delay time according to the second assistance calculation capability and the offload request; and
when determining that the node server has the second thread, the second assistance capacity is greater than the preset capacity and the second delay time lies within the preset time range, classifying the node server as a target type node server;
when a number of the target type node server is at least one, selecting a target server from the at least one target type node server according to the response signal corresponding to the at least one target type node server, and obtaining an offloading message about the offload request from the local server and performing the offload request on the second thread by the target server.

14. The method of offloading task between nodes according to claim 13, wherein when the number of the target type node servers are multiple, selecting the target server from the target type node servers according to the response signals corresponding to the target type node servers comprising:
generating a distance between each of the target type node servers and the local server and a channel timing delay and channel quality of each of the target type node servers according to the response signals corresponding to the target type node servers; and
selecting the target server from the target type node servers according to the channel timing delays, the channel quality and the distances of the target type node servers.

15. The method of offloading task between nodes according to claim 13, further comprising:
when the first assistance capacity is greater than the preset capacity, there is the first thread in the local server, and the first delay time lies within the preset time range, determining whether to retain the first assistance calculation capability;
when determining to retain the first assistance calculation capability and obtaining the response signal from at least one of the plurality of node servers, performing the classification procedure on the node server corresponding to the response signal;
when determining not to retain the first assistance calculation capability, performing the offload request on the first thread.

16. The method of offloading task between nodes according to claim 15, further comprising:
when determining to retain the first assistance calculation capability and not obtaining the response signals from the plurality of node servers after preset wait time, performing the offload request.

17. The method of offloading task between nodes according to claim 13, further comprising:
when the first assistance capacity is not greater than the preset capacity, there is not the first thread in the local server, the first delay time does not lie within the preset time range, and not obtaining the plurality of response signals from the plurality of node servers after preset wait time, performing the offload request.

18. The method of offloading task between nodes according to claim 13, wherein the classification procedure further comprising:
when determining that the node server does not have the second thread, the second assistance capacity is not greater than the preset capacity or the second delay time does not lie within the preset time range, classifying the node server as a non-target type node server.

19. The method of offloading task between nodes according to claim 18, further comprising:
when the plurality of node servers belong to the non-target type node server, determining whether the offload request is a real-time calculation request.

20. The method of offloading task between nodes according to claim 19, wherein the edge computing network further comprises a cloud side, and the method of offloading task between nodes further comprising:
when determining that offload request is the real-time calculation request, refusing the offload request and transmitting an assistance message to a cloud server belonging to the cloud side, and examining operation situations of the local server and the plurality of node servers by the cloud server;
when determining that offload request is not the real-time calculation request, transmitting the offload request and the assistance message to the cloud server, and processing the offload request by the cloud server.

21. The method of offloading task between nodes according to claim 13, further comprising:
when receiving the offload request, performing an identification procedure on the client device to generate an identification result;
when the identification result is a legal client, ensuring the first assistance calculation capability, the first assistance capacity and the first thread, and calculating the first delay time according to the first assistance calculation capability and the offload request;
transmitting the ensuring request to the plurality of node servers;
when the identification result is an illegal client, refusing the offload request.
